(19) United States
(12) Patent Application Publication
(10) Pub. No.: US 2009/0269378 A1
(43) Pub. Date: Oct. 29, 2009

(54) USE OF TANNINS IN FILTERS

(75) Inventors: Stephan Hueffer, Ludwigshafen (DE); Oliver Reese, Lemfoerde (DE); Guenter Scherr, Ludwigshafen (DE); Sebastien Garnier, Weinheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/300,935

(22) PCT Filed: Feb. 28, 2007
(86) PCT No.: PCT/EP07/51885

§ 371 Date: Nov. 28, 2008

(30) Foreign Application Priority Data
May 17, 2006 (EP) 06114063.8

(51) Int. Cl. A01N 25/34; B05D 3/00; A01P 1/00

(52) U.S. Cl. 424/402; 427/2.3

(57) ABSTRACT

The present invention relates to the use of a tanning agent in or on filters, in particular natural or synthetic fibrous fabric or foams, for the avoidance of infections, these filters in particular being part of respiratory protection masks or respiratory protection apparatuses.

The present invention relates to the use of a tanning agent in or on filters, in particular natural or synthetic fibrous fabric or foams, for the avoidance of infections, these filters in particular being part of respiratory protection masks or respiratory protection apparatuses. Furthermore, the present invention also relates to the filters as such, which comprise (at least) one tanning agent.

The use of filters in the form of textile protective clothing or protective masks for the avoidance of infections has been known for a relatively long time. The protective action can serve both the wearer and the environment here. The protective action is based mainly on a retention of microorganisms (pathogens) in the fabric. The problem here is that, for example, as a result of the respiratory air, the bodily perspiration or the environmental air, moisture is constantly supplied to the fabric, whereby the microorganisms in the fabric can remain active for a longer time under certain circumstances. In the case of sudden strong air movements, for example as a result of sneezing or taking deep breaths, such pathogens can leave the fabric or the filter again.

Thus EP-B 0 859 547 relates to protective equipment such as surgical masks or drapes and other surgical clothing which are useful for the inactivation of viruses on contact. This is achieved by a coating of immobilized polymer molecules being applied to the corresponding textile material substrate, which provides the textile material substrate with antiviral activity which cannot be washed out, the polymer molecules comprising a hydrophilic polymer having antiviral side groups which comprise a number of cationic side groups and a number of hydrocarbon side chains and the polymer molecules further comprising the radicals of photo-chemically reactive side groups. The hydrophilic polymer which comprises the coating base of the textile substrate can, for example, be a copolymer of vinyl-pyrrolidone or acrylamide.

U.S. Pat. No. 4,897,304 relates to protective clothing against viruses, the protective clothing being based on cellulose fabric or nonwoven fabric which in turn comprises an anionic surfactant and an acid such as, for example, citric acid or benzoic acid.

U.S. Pat. No. 5,690,949 relates to a microporous membrane which can prevent the passage of viruses. The microporous membrane material comprises a thermoplastic polymer, a further compound which is miscible with the thermoplastic polymer, for example a liquid hydrocarbon such as mineral oil, and a water- and oil-repellent fluorine-containing compound, which makes possible the barrier for viruses in the membrane.

The fact that tanning agents can also be used for the prevention or avoidance of infections in filters such as natural or synthetic fibrous fabrics and microporous membrane materials which in particular are part of respiratory protection masks or respiratory protection apparatuses, however, is not known.

Tanning agents can in principle be divided into three main classes (see Römpps Chemie Lexikon [Römpp's Chemical Encyclopedia], 9th edition (1995), Georg Thieme Verlag Stuttgart, keyword “tanning agents”, pages 1541 to 1542):

1. inorganic tanning agents such as chromium(III) salts or polyphosphates; 2. synthetic organic tanning agents, which are usually obtainable by sulfonation of solubilized aldehyde condensation products of aromatic parent substances, in particular of phenol, cresol, naphthalene and naphthol; and 3. tanning agents of plant origin such as can occur in leaves (tea), seeds (coffee), berries, galls or woods. In the narrower sense, tanning agents of plant origin are understood as meaning the “tannic acids” or tannins, catechols or gallic acid derivatives.

Examples of synthetic tanning agents are found, for example, in the German application having the number DE 10 2005 050 193.1 and in EP-A 0 301 406. In these documents, the “classical use” of tanning agents is described, that is the tanning of leathers or (animal) skins. Another use of tanning agents, such as, for example, as medicaments is not disclosed therein, however.

Both the tanning agents of plant origin (subsequently designated as plant or natural tanning agent) and the synthetic organic tanning agents (subsequently designated as synthetic tanning agent) are connected in the literature with use as medicaments, in particular with antiviral action. This applies in particular to plant synthetic tanning agents, which are designated as “polyphenols”.

For example, for plant tanning agents such as tannins an antiviral activity (in particular against herpes simplex) and antitumor activity of these natural tanning agents is described in T. Okuda, Phytochemistry, volume 66 (2005), pages 2012 to 2031 or Fukuji et al., Antiviral Res. 11 (1989), pages 285 to 298. Further examples of the use of natural tanning agents as medicaments are found in H. Sakagami et al., Anticancer Research 17 (1997), pages 377 to 380; H. Nakashima et al., Antiviral Research 18 (1992), pages 91 to 103 and H. Sakagami et al., Anticancer Research 15 (1995), pages 2121 to 2128.

Furthermore, propolis, which is collected by bees from the buds, bark and resins of certain trees and comprises plant tanning agents, is attributed, inter alia, an antiviral activity, for example against herpes simplex. Propolis, which is a polyphenol, can be composed, depending on the bee colony, of up to 200 different constituents, in particular these are chalcones, flavanones, flavones and flavanols (S. Bogdanov, Schweizerisches Zentrum für Bienenforschung [Swiss Center for bee research]; article obtainable from the Internet; http://www.apis.admin.ch/de/bienenprodukte/docs/produkte/propolis_d.pdf). Propolis can also have an impregnating action on wood in the form of a protective paint, by, for example, coating the outer walls of beehives with concentrated propolis-fuel alcohol solution.

In the case of synthetic tanning agents too, pharmaceutical applications are already known. Thus, WO 95/14479 relates to a condensation polymer of aromatic sulfonic acids and an aldehyde for the inhibition of the HIV virus. It is described there that the higher the molecular weight of the polymer, the greater its therapeutic activity. Likewise, in U.S. Pat. No. 4,604,404 the use of sulfonated naphthalene-formaldehyde condensation polymers for the control of herpes simplex virus is described.

Furthermore, DE-A 33 41 122 describes virucidal medicaments to be applied externally, in particular against herpes labilis and virus diseases of the skin. These medicaments are synthetic tanning agents, prepared by condensation of, for example, urea with phenol/cresol, formaldehyde and a sulfonating agent.

In DE 10 2004 034613, condensation products are described which are obtainable by reaction of at least one aromatic system, at least one sulfonating agent, at least one carbonyl compound and if appropriate at least one urea derivative. Following the synthesis, the condensation products are subjected to at least one molecular size-dependent separation process. Here, the condensation product was separated into three fractions, a high molecular weight, a medium molecular weight and a low molecular weight fraction. It was found that the high molecular weight fractions have an improved activity with respect to the inhibition of the activity of the enzyme human leucocyte elastase than the corresponding medium molecular weight fraction of this condensation product.

The uses of synthetic or plant tanning agents described above relate in particular to their use as a (constituent of a) medicament. In this connection, the synthetic or plant tanning agents are thus administered to a mammal, in particular man, for example for oral intake. In the prior art, however, it is not described anywhere that tanning agents generally, in particular synthetic or plant tanning agents, can also contribute outside the human body (that is without direct administration as a medicament) to the avoidance of infections, for example as a component of a respiratory protection mask, of a respiratory protection apparatus, of a surgical mask or also as part of a filter system for air preparation such as, for example, in air-conditioning plants and aseptic chambers.

The invention was thus based on the object of making available further filters, for example in the form of natural or synthetic fibrous fabrics, in particular as a component of a respiratory protection mask or of a respiratory protection apparatus.

According to the invention, this object is achieved by the use of one or more tanning agents in or on filters for the avoidance of infections or by filters as such, comprising at least one tanning agent.

An advantage of the present invention can be seen in that tanning agents can be fixed stably on or in the corresponding filters, for example in or on fibrous fabrics. In particular in their use as a component of respiratory protection masks and respiratory protection apparatuses, this is advantageous, since the respiratory protection masks and respiratory protection apparatuses or filter systems known from the prior art are often provided with volatile and/or mucous membrane-irritating substances. Tanning agents, however, are neither volatile (or at least only very slightly volatile), nor irritating to the mucous membrane and moreover fixing to the appropriate filter is easily possible. For this reason, tanning agents are particularly effectively suitable for the prevention or avoidance of infections and the spread of infections. The tanning agents (largely) eliminate the pathogens and thus prevent the penetration of the filters used even under unfavorable conditions. Furthermore, the tanning agents are also active over a relatively long period with respect to the properties described above.

A suitable tanning agent is in principle any tanning agent known to the person skilled in the art. As already mentioned above, Römpp's Chemielexikon [Römpp's Chemical Encyclopedia], 9th edition (1995), Georg Thieme Verlag, Stuttgart, keyword “tanning agents”, pages 1541 to 1542 provides a survey of tanning agents known to the person skilled in the art. Preferably, plant or synthetic tanning agents are used in the context of the present invention. Synthetic tanning agents are particularly preferred.

Examples of plant tanning agents are tannins such as catechols or gallic acid derivatives such as gallates. Plant tanning agents which are based on gallic acid derivatives (such as gallates) differ from the condensation products according to the invention in particular in that the last-mentioned have in their chemical structures (a multiplicity of) —CR¹R² bridges (crosslinkages), which are derived from the carbonyl compound a2) employed and which are not present in plant tanning agents. If, for example, formaldehyde is employed as component a2), the condensation products have —CH₂ bridges. Plant tanning agents (gallates) are typically oligomeric systems, whereas the condensation products according to the present invention are preferably polymers.

Preferred plant tanning agents are tannins from the group consisting of the catechols, epicatechols and epigallocatechols and their gallates.

Tannin is understood in principle as meaning naturally occurring polyphenols, such as are mentioned, for example, in T. Okuda, Phytochemistry, volume 66 (2005), pages 2012 to 2031 or Römpp's Chemie Lexikon, 9th edition (1995), Georg Thieme Verlag, Stuttgart, keyword “tannins”, pages 4452 to 4453. Preferred tannins are ellagitannins and dehydroellagitannins, in particular geraniin, dehydrogeraniin, furosinin, ascorgeraniin, geraniinic acid, mallotusinic acid, pentagalloylglucose, camelliatannin A, casuariin, euphorbin E, camelliatannin F, agrimoniin, trapanin B, oenothein A, oenothein B or gemin D, lignin and ligninsulfonates. Catechols, epicatechols and epigallocatechols are furthermore preferred.

Examples of a suitable catechol or derivatives thereof in particular comprise flavan-3-ols, flavan-3,4-diols (leucoanthocyanidins) and flavanones, flavones, chalcones or dihydrocychalcones, epicatechols and epigallocatechols.

Examples of suitable gallic acid derivatives are mentioned, for example, in H. Sakagami et al, Anticancer Research 17 (1997), pages 377 to 380. Preferably, these are gallic acid, methyl tri-O-methylgallate, tri-O-methylgallic acid, methyl tri-O-acetylgallate, methyl gallate, ethyl gallate, n-propyl gallate, isoamyl gallate, lauryl gallate, stearyl gallate, epigallocatechol gallate and gallic acid.

For example, extracts of green tea can also be employed as plant tanning agents, likewise extracts of chestnuts or mimosa.

Suitable synthetic tanning agents are in principle all tanning agents which can be prepared synthetically. Synthetic tanning agents should not be understood as meaning plant tanning agents, such as, for example, the aforementioned tannins or catechols and gallic acid derivatives, even if these are also accessible synthetically.

Preferred synthetic tanning agents are selected from the condensation products (A) to (C), which are defined below.

### Condensation Product (A)

Condensation product (A) is obtainable by reaction of

a1) at least one aromatic system or heteroaromatic system,
a2) at least one carbonyl compound,
a3) if appropriate at least one sulfonating agent and
a4) if appropriate at least one urea derivative.

The individual components are defined as follows:

a1) at least one aromatic system or heteroaromatic system

Aromatic systems are understood as meaning compounds having at least one phenyl ring, which can be substituted and which can also comprise a number of fused phenyl systems, for example naphthyl systems, phenanthrene systems and anthracene systems. Optionally, in bi- or polycyclic systems individual cycles can also be completely or partly saturated, provided that at least one cycle is aromatic.

Heteroaromatics are described in the present invention as aromatic systems, which are preferably monocyclic or bicyclic, if appropriate also polycyclic, and contain at least one heteroatom, preferably selected from nitrogen, oxygen and sulfur. Examples of a heteroaromatic system are: pyrrole, furan, thiophene, imidazole, pyrazole, 1,2,3-triazole, 1,2,4-triazole, 1,3-oxazole (═Oxazole), 1,2-oxazole (=isoxazole), oxadiazole, 1,3-thiazole (=thiazole), 1,2-thiazole (=isothiazole), tetrazole, pyridine, pyridazine, pyrimidine, pyrazine, 1,2,3-triazine, 1,2,4-triazine, 1,3,5-triazine, 1,2,4,5-tetrazine, indazole, indole, benzothiophene, benzofuran, benzothiazole, benzimidazole, quinoline, isoquinoline, quinazoline, cinnoline, quinoxaline, phthalazine, thienothiophene, 1,8-naphthyridine, other naphthyridines, purine or pteridine. Provided they are not monocyclic systems, in the case of each of the aforementioned heteroaromatic systems also the saturated form (perhydro form) or the partly unsaturated form (for example the dihydro form or tetrahydro form) or the maximally unsaturated (nonaromatic) form is additionally included for the second ring, provided the respective forms are known and stable. In the present invention, the description heteroaromatic thus also comprises, for example, bi- or polycycles in which (in the case of the bicyclic system) both rings are aromatic, and bicyclic systems in which only one ring is aromatic. Such examples for heteroaromatic systems are: 3H-indoline, 2(1H)-quinolinone, 4-oxo-1,4-dihydroquinoline, 2H-1-oxoisoquinoline, 1,2-dihydroquinoline, 3,4-dihydroquinoline, 1,2-dihydroisoquinolinyl, 3,4-dihydroisoquinoline, oxindolyl, 1,2,3,4-tetrahydroisoquinoline, 1,2,3,4-tetrahydroquinoline, 5,6-dihydroquinoline, 5,6-dihydroisoquinoline, 5,6,7,8-tetra-hydroquinoline or 5,6,7,8-tetrahydroisoquinoline.

Preferably, at least one aromatic system or heteroaromatic system is selected from benzene, naphthalene, anthracene, aromatic alcohols, aromatic ethers and aromatic sulfones.

The aromatic or heteroaromatic system (component a1) can be unsubstituted or at least monosubstituted. If one or more substituents are present, these are independently of one another chosen from C₁-C₁₀-alkyl groups such as, for example, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particularly preferably C₁-C₄-alkyl such as methyl, ethyl, n-propyl, isopropyl, n-butyl, isobutyl, sec-butyl and tert-butyl,

C₂-C₁₀-alkenyl groups, in particular vinyl, 1-allyl, 3-allyl, 2-allyl, cis- or trans-2-butenyl, ω-butenyl,
C₆-C₁₄-aryl groups aryl, such as, for example, phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl,
or benzyl groups.

Examples of preferred aromatic systems or heteroaromatic systems are:

benzene, toluene, ortho-xylene, meta-xylene, para-xylene, ethylbenzene, cumene, para-methylcumene, biphenyl, 2-methylbiphenyl, 3-methylbiphenyl, 4-methylbiphenyl, bitolyl (4,4′-dimethylbiphenyl), para-terphenyl, indene, fluorene, methylindenes (isomer mixture), naphthalene, 1-methylnaphthalene, 2-methylnaphthalene, 1,8-dimethylnaphthalene, 2,7-dimethylnaphthalene, phenanthrene, anthracene, 9-methylanthracene, 9-phenylanthracene.

Examples of aromatic alcohols which may be mentioned are: phenol, ortho-cresol, meta-cresol, para-cresol, 2-ethylphenol, 3-ethylphenol, 4-ethylphenol, 2,3-dimethylphenol, 2,4-dimethylphenol, 2,5-dimethylphenol, 2,6-dimethylphenol, 3,4-dimethylphenol, 3,5-dimethylphenol, gallic acid (trihydroxybenzoic acid), α-naphthol, β-naphthol, 9-hydroxyanthracene as a tautomer of anthrone, 9-hydroxyphenanthrene, diphenylmethane, phenyl-(2-methylphenyl)methane, phenylparatolylmethane, phenylmetatolylmethane.

Examples of aromatic ethers which may be mentioned are: diphenyl ether, di-ortho-tolyl ether, di-meta-tolyl ether and di-para-tolyl ether.

Examples of aromatic sulfones which may be mentioned are diphenylsulfone and 4,4′-dihydroxydiphenylsulfone.

Component a1) is particularly preferably at least one compound selected from phenol, phenolsulfonic acid, 4,4′-dihydroxydiphenylsulfone and gallic acid.

In one embodiment of the present invention, mixtures of at least 2 aromatic systems are employed as component a1), for example mixtures of naphthalene and phenol, naphthalene and cresol (isomer mixture), naphthalene and diphenyl ether, naphthalene and ditolyl ether or phenol and ditolyl ether.

a2) at least one carbonyl compound
selected from aldehydes and ketones, preferably containing at least one aldehyde such as formaldehyde, acetaldehyde or propionaldehyde and in particular containing formaldehyde. If it is desired to employ formaldehyde, it is preferred to employ formaldehyde in aqueous solution.
a3) if appropriate at least one sulfonating agent

Suitable sulfonating agents are, for example, sulfuric acid, in particular concentrated sulfuric acid, furthermore oleum having an SO₃ content of 1 to 30% by weight, furthermore chlorosulfonic acid and amidosulfonic acid. Concentrated sulfuric acid and oleum having an SO₃ content of 1 to 15% by weight are preferred.

a4) if appropriate at least one urea derivative

In principle, urea and all derivatives thereof are suitable as component a4). A urea derivative is preferred which carries at least one hydrogen atom on each nitrogen atom.

Particularly preferably, at least one urea derivative is chosen from compounds of the general formula (I)

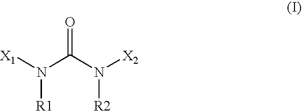

in which the variables are defined as follows:
X¹, X² are different or preferably identical and chosen from hydrogen and —CH₂OH,
R¹, R² are different or preferably identical and are chosen from hydrogen, C₁-C₁₀-alkyl such as, for example, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particularly preferably C₁-C₄-alkyl such as methyl, ethyl, n-propyl, isopropyl, n-butyl, isobutyl, sec-butyl and tert-butyl, or
R¹ and R² together form a C₂-C₁₀-alkylene unit, unsubstituted or substituted by 2 to 5 hydroxyl groups, such as, for example, —(CH₂)₂—, —CH₂—CH(CH₃)—, —(CH₂)₃—, —CH₂—CH(C₂H₅)—, —(CH₂)₄—, —(CH₂)₅—, —(CH₂)₆—, —(CH₂)₇—, —(CH₂)₈—, —(CH₂)₉—, —(CH—OH)₂—(cis or trans), preferably C₂-C₄-alkylene; in particular —(CH₂)₂—, —(CH₂)₃—, and —(CH—OH)₂— (cis or trans).

(Unsubstituted) urea, melamine or the cyclic urea derivatives of the formulae I.1, I.2 or I.3 are very particularly preferred

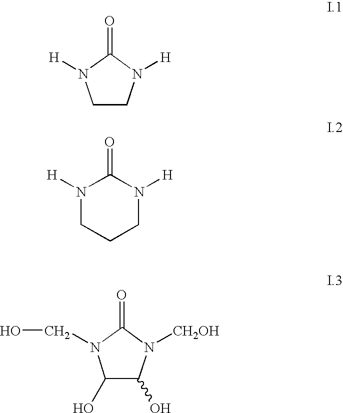

Processes for the preparation of a condensation product (A) are known to the person skilled in the art, for example they are described in DE-A 10 2004 034 631, DE-A 1 113 457, EP-A 26314, and in Ullmann's Encyclopedia of Industrial Chemistry, volume A15, page 259-282, 5th edition, (1990), Verlag Chemie Weinheim.

In principle, the individual starting components can be reacted in any desired sequence. For example, in one embodiment of the present invention one or more further reactants a5) can also be added during the reaction, for example NaHSO₃, Na₂S₂O₅, KHSO₃, K₂S₂O₅, aqueous alkali metal hydroxide solution, in particular aqueous sodium hydroxide solution and aqueous potassium hydroxide solution, and aqueous ammonia. The reactant a5) serves in particular for the adjustment of the pH and the control of the solubility of the final product.

In a further embodiment of the present invention, in the preparation of the condensation product (A), after reaction of components a1) and a2) and if appropriate a3) and a4) a molecular size-dependent separation process can be carried out, preferably an ultrafiltration, with obtainment of individual fractions of the condensation product (A), for example a low molecular weight, a medium molecular weight and a high molecular weight fraction. The high molecular weight fraction has, for example, an M_{w} value≧9000 g/mol (M_{w}=weight-average molecular weight), preferably an M_{w} value of 10 000 to 100 000 g/mol. The low molecular weight fraction preferably has an M_{w} value of 300 to 3000 g/mol.

Suitable molecular size-dependent separation processes are, for example: preparative gel permeation chromatography and membrane separation processes such as, for example, microfiltration, nanofiltration and in particular ultrafiltration. Combinations of microfiltration and ultrafiltration are also suitable. Microfiltrations and ultrafiltrations and membranes necessary therefor are known as such and described, for example, in Ullmann's Encyclopedia of Industrial Chemistry, 6th edition, vol. 21, Wiley-VCH Weinheim, pp. 243-321. Nanofiltrations and the membranes associated with them are likewise known as such and described in R. Rautenbach, “Membranverfahren” [Membrane Processes], Springer Verlag Berlin Heidelberg 1997. The exact procedure for the separation of the condensation product (A) into individual fractions as a function of the molecular weight is known to the person skilled in the art and disclosed, for example, in DE-A 10 2004 034 613.

### Condensation Product (B)

Condensation product (B) is obtainable by reaction of

b1) at least one cyclic organic carbonate with
b2) at least one compound having at least two nucleophilic groups per molecule, chosen from sulfonic acid groups, hydroxyl groups, primary or secondary amino groups or mercapto groups.

Preferably, the condensation product (B) has an M_{w} value between 300 and 3000 g/mol.

Condensation products (B) as such and processes for their preparation are known to the person skilled in the art; they are disclosed, for example, in the German application having the number DE 10 2005 050 193.1 and included by reference in the present invention.

Cyclic organic carbonates (component b1) are understood in the context of the present invention as meaning organic carbonic acid esters which contain at least one cyclic group.

Preferably, cyclic organic carbonates are those organic carbonic acid esters in which the carbonic acid ester group is part of a cyclic system.

In one embodiment of the present invention cyclic organic carbonate (b1) is chosen from compounds of the general formula (II)

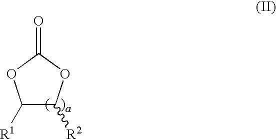

where the variables are defined as follows:
R¹ chosen from C₁-C₄-alkyl, branched or preferably linear, for example, methyl, ethyl, n-propyl, isopropyl, n-butyl, isobutyl, sec-butyl, tert-butyl, very preferably methyl and ethyl, and very particularly preferably hydrogen,
R² if appropriate different or preferably identical and independently of one another chosen from hydrogen and C₁-C₄-alkyl, branched or preferably linear, for example, methyl, ethyl, n-propyl, isopropyl, n-butyl, isobutyl, sec-butyl, tert-butyl, very preferably methyl and ethyl, and very particularly preferably in each case identical and hydrogen,
   a an integer in the range from 1 to 3, preferably 2 and particularly preferably 1.

Particularly preferred cyclic organic carbonates b1) are propylene carbonate, ethylene carbonate. Mixtures of propylene carbonate (R¹=methyl, R²=hydrogen, a=1) and ethylene carbonate (R¹=R²=hydrogen, a=1), in particular mixtures of propylene carbonate and ethylene carbonate which are liquid at room temperature are likewise particularly preferred.

Component b2) is understood as meaning those compounds which contain two groups capable of nucleophilic reactions such as, for example, sulfonic acid groups, hydroxyl groups, mercapto groups or primary or secondary amino groups.

Examples of suitable compounds b2) can contain:

at least two nucleophilic hydroxyl groups per molecule,
at least two nucleophilic mercapto groups per molecule,
at least two nucleophilic primary or secondary amino groups per molecule, for example, two or three nucleophilic primary or secondary amino groups per molecule,
at least one nucleophilic hydroxyl group or mercapto group and at least one nucleophilic primary or secondary amino group per molecule or
at least one nucleophilic hydroxyl group and at least one nucleophilic mercapto group per molecule,
at least one nucleophilic hydroxyl group or primary or secondary amino group and one sulfonic acid group per molecule.

Sulfuric acid is not a compound b2) within the meaning of the present invention.

Examples of nucleophilic hydroxyl groups are OH groups of primary and secondary alcohols and in particular phenolic OH groups.

Examples of nucleophilic mercapto groups are SH groups, aliphatic or aromatic.

Examples of nucleophilic amino groups are —NHR³ groups, aliphatic or aromatic, where R³ is chosen from hydrogen, C₁-C₄-alkyl, as defined above, and CN, or the NH₂ group of, for example, amidosulfonic acid.

OH groups and NH groups, which are constituents of aminal groups, hemiaminal groups or hydrate groups of ketones or aldehydes, are not nucleophilic hydroxyl groups or amino groups within the meaning of the present invention. OH groups and NH groups which are constituents of carboxylic acid groups or carboxylic acid amide groups are not nucleophilic hydroxyl groups or amino groups within the meaning of the present invention.

Preferred examples of compounds b2) are
i) ureas, unsubstituted or mono- or di-N,N′-substituted by C₁-C₄-alkyl, biuret, in particular unsubstituted urea,
ii) heterocyclic compounds having at least two NH₂ groups per molecule, for example adenine and in particular melamine,
iii) benzoguanamine, dicyandiamide, guanidine,
iv) compounds of the general formula (III)

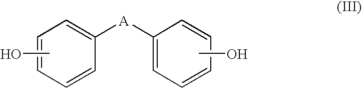

in which A is a bivalent group, for example —CH₂—, —CH₂CH₂—, —CH(CH₃)—, —C(CH₃)₂—, —CO—, —SO₂—, preferably 4,4′-dihydroxybiphenyl, 2,4′-dihydroxydiphenylsulfone, particularly preferably 4,4′-dihydroxydiphenylsulfone, mixtures of 4,4′-dihydroxydiphenylsulfone and 2,4′-dihydroxydiphenylsulfone, for example, in a weight ratio of 8:1 to 8:1.5, and bisphenol A.

Further preferred examples of compound b2) are 4-hydroxyphenylsulfonic acid and amidosulfonic acid.

Particularly preferred compounds b2) are selected from melamine, biuret, di-cyandiamide, amidosulfonic acid and 4,4′-dihydroxydiphenylsulfone.

### Condensation Product (C)

Condensation product (C) is obtainable by reaction of
c1) melamine and/or urea
c2) glyoxal, glyoxylic acid and/or an alkali metal salt thereof,
c3) if appropriate at least one aromatic compound having at least one phenolic hydroxyl group and
c4) if appropriate at least one condensable compound having a reactive nitrogen-containing group.

Preferably, the condensation product (C) has an M_{w} value between 300 and 3000 g/mol.

The condensation products (C) as such and processes for their preparation are known to the person skilled in the art. For example, these are described in EP-A 0 301 406 and are included by reference in the present invention.

Suitable components c3) are, for example, phenolsulfonic acid, sulfosalicylic acid, salicylic acid and 8-hydroxyquinoline. Suitable components c4) are carboxamides, sulfonamides, imides, ureas, amino and imino acids and also dialkylamines and dialkanolamines. Examples of these are acetamide, benzamide, formamide, amidosulfonic acid, succinimide, glycine, iminodiacetic acid, phenylglycine, urea, dicyandiamide, diethanolamine or diethylamine. Acidic compounds can be condensed here in the form of their alkali metal salts. Acetamide and amido-sulfonic acid are particularly preferred as component c4).

A preferred condensation product (C) is obtainable by reaction of
c1) melamine and/or urea, and
c2) glyoxal and/or glyoxylic acid, and
c4) if appropriate amidosulfonic acid.

In a preferred embodiment of the present invention, a tanning agent is employed which comprises at least one hydroxyl group or is substituted by such a group. In the case of the condensation products (A), (B) or (C) this is preferably achieved by

the component a1) comprising at least one compound which is substituted by at least one hydroxyl group and/or
the component b2) comprising at least one compound which is substituted by at least one hydroxyl group and/or
the component c3) being present.

Within the bounds of the present invention, filters are understood in principle as meaning any type of materials (substrates or filter base) which exert a filter action. Preferably, the filter comprises a natural or synthetic fibrous fabric, a foam, a film, a textile, polymer fibers and/or a matrix having cavities within the matrix. The filter can here comprise one or more of these preferred components, if appropriate the filter can also be formed completely of one or more of these components. The term “fibrous fabric” should here also comprise fibrous fabrics which are not textiles, likewise the term “textiles” should also comprise those textiles which are not fibrous fabric. Films are preferably porous, polymer fibers are preferably water-insoluble. Fibrous fabric can be natural or vegetable. Particularly preferred filters are foams or natural or synthesized fibrous fabric. Filters, in particular natural or synthetic fibrous fabric, should not be understood, however, as meaning skins, in particular skins originating from animals, and wood or wood products.

Preferably, the natural or synthetic fibrous fabric is woven or nonwoven fibrous fabric, in particular that of cellulose, cellulose derivatives, cotton, nonwoven, wool, silk, polyamides (nylon), polypropylene, polyester, other plastics (e.g. viscose, acetate (partly synthetic), polyacrylates, polyvinyl chloride (PVC) and blends of the polymers) and glass fibers. The fibers can also be connected to one another by means of a polymer matrix.

Foam should preferably be understood as meaning polyurethane-amino resin condensates, which preferably form a microporous and/or open-pore system. Melamine-formaldehyde condensates are particularly preferred. Foams as such are known to the person skilled in the art.

Suitable fiber-based filter materials are commercially obtainable, e.g. from Freudenberg Faserfliesstoffe KG (Weinheim, Germany), Sontara Technologies (subsidiary of the DuPont Corporation, Old Hickory, Tenn., USA), Lystil S.A. (Brignoud Cedex, France), Dexter Nonwovens (Windsor Locks, Conn., USA). Suitable foam-based filter materials can be obtained, for example, from BASF AG (Ludwigshafen, Germany) under the trademark Basotect®.

A further subject of the present invention is thus a filter as such, comprising at least one tanning agent (according to the above definitions with respect to tanning agents).

Preferably, the filter is part of a respiratory protection mask or of a respiratory protection apparatus or of a filter system, for example of an air conditioning plant. If appropriate, the filter can also completely form the respiratory protection mask or the respiratory protection apparatus. It is also possible to equip the filter (article) in a multilayer embodiment, inter alia, with foamed, open-pore polymer inlays. These foamed polymers (polyurethanes, melamine-formaldehyde condensates such as, for example, Basotect® from BASF AG) can also serve to absorb the active substrate according to the invention in the form of a surface coating.

Furthermore, the filters according to the invention can also be part of surgical articles, in particular drapes or surgical masks, or the filters according to the invention can completely form these articles.

Processes for the production of a filter, for example of a fibrous fabric, and processes for the production of respiratory protection masks, respiratory protection apparatuses or surgical articles, or the introduction of the corresponding filters into respiratory protection masks, respiratory protection apparatuses or surgical articles are known to the person skilled in the art. Furthermore, it is also known to the person skilled in the art how tanning agents can be applied to articles, such as leather.

The tanning agent(s) can be applied or introduced, in particular incorporated, according to the present invention into or onto the filter, in particular the fibrous fabric. If the tanning agent is applied to the fibrous fabric, it is preferably present in the form of a coating. Preferably, the filter or the fibrous fabric is fulled or sprayed or treated in the roll coating process with an aqueous solution of one or more tanning agents. The coating can be applied for example either before the processing of a textile to the article or to the article itself. A process is also conceivable in which during or immediately after the fiber production (e.g. with viscose, nylon or polypropylene (PP) fibers) the fibers are suitably impregnated/coated. If appropriate, the tanning agent(s) can also be incorporated into the fibrous fabric and the fibrous fabric is covered with a further fibrous fabric, which can be identical or different.

Owing to the presence of one or more tanning agents in or on filters, in particular natural or synthetic fibrous fabric or foams, avoidance of infections is achieved. This is in particular applicable if the corresponding filter is part of a respiratory protection mask or of a respiratory protection apparatus or forms them completely. By the use of the tanning agents, a depletion and/or elimination of microorganisms such as, for example, viruses or bacteria from the air, in particular from the respiratory air, can be achieved.

The invention will be illustrated by the following examples.

### EXAMPLES

### Synthesis Examples of Formaldehyde-Free Low Molecular Weight Tanning Agent

### Example NM1 Condensation Product (C)

### Reactants

urea
glyoxal

33.0 g (549 mmol) of urea are dissolved in 180 ml of water in a flask and heated to 50° C. with stirring. 218 g (1.50 mol) of glyoxal solution (40%) are added at this temperature and the mixture is stirred for a further 30 min. After cooling to room temperature, it is adjusted to a pH of 5 using sodium hydroxide solution (50%). About 430 g of a clear solution are obtained having a solids content of 28%. M_{w}=2850 g/mol, M_{w}/Mₙ=11.3 where M_{w}=weight-average molecular weight, Mₙ=number-average molecular weight.

### Example NM2 Condensation Product (C)

### Reactants

melamine
glyoxal

A mixture of 193.0 g of 40% strength aqueous glyoxal solution (1.33 mol) and 21.0 g of melamine (0.17 mol) are warmed to 40° C. for 15 min, a clear solution resulting. Subsequently, this is cooled and adjusted with 31.5 g of water to a solids content of calculated 40% M_{w}=2640 g/mol, M_{w}/Mₙ=8.8.

### Example NM3 Condensation Product (B)

### Reactants

melamine
ethylene carbonate
sulfuric acid

24.0 g (190 mmol) of melamine, 200 g (2.27 mol) of ethylene carbonate and 1.40 g (17.5 mmol) of aqueous sodium hydroxide solution (50% by weight) are introduced into a flask and heated to 170° C. with stirring. The mixture thus obtained is stirred at 170° C. until evolution of gas can no longer be observed. It is subsequently cooled to room temperature, and 102 g of water are added. A pH of 5 is adjusted using aqueous sulfuric acid (50% by weight). About 250 g of condensation product (B) are obtained, solids content: 48% M_{w}=960 g/mol, M_{w}/Mₙ=3.6.

### Example NM4 Condensation Product (B)

### Reactants

urea
ethylene carbonate
potassium carbonate
sulfuric acid

7.60 g (127 mmol) of urea, 200 g (2.27 mol) of ethylene carbonate and 1.5 g (10.9 mmol) of potassium carbonate are introduced into a flask and heated to 170° C. with stirring. The mixture thus obtained is stirred at 170° C. until evolution of gas can no longer be observed. It is subsequently cooled to room temperature, 125 g of water are added and a pH value of 5 is adjusted using aqueous sulfuric acid (50% by weight). 250 g of condensation product (B) are obtained. Solids content: 47%, M_{w}=1920 g/mol, M_{w}/Mₙ=4.8.

### Examples for Condensation Products (A)

### General Preliminary Remarks:

Solutions are always understood as meaning aqueous solutions if not expressly specified otherwise.

ppm always relates to parts by weight.

The molecular weight determinations are carried out using gel permeation chromatography (GPC):

Stationary phase: poly(2-hydroxymethacrylate) gel crosslinked with ethylene glycol dimethacrylate, obtainable commercially as HEMA BIO from PSS, Mainz, Germany.

Eluent: mixture of 30% by weight of tetrahydrofuran (THF), 10% by weight of acrylonitrile, 60% by weight of 1 molar NaNO3 solution

Internal standard: 0.001% by weight of benzophenone, based on eluent

Flow: 1.5 ml/min

Concentration: 1% by weight in the eluent containing internal standard

Detection: UV/Vis spectrometrically at 254 nm

Calibration using polystyrene calibration part from PSS.

Mₙ: number-average molecular weight in [g/mol]

M_{w}: weight-average molecular weight in [g/mol]

For the determination of free formaldehyde, a flow injection apparatus according to Huber is employed, see Fresenius Z. Anal. Chem. 1981, 309, 389. The column chosen is a thermostatted reaction column 170×10 mm, filled with glass beads, which is operated at 75° C. The detector (continuous flow detector) is set at a wavelength of 412 nm. The procedure is as follows:

For the preparation of a reagent solution, 62.5 g of ammonium acetate are dissolved in 500 ml of distilled water, 7.5 ml of concentrated acetic acid and 5.0 ml of acetylacetone are added and filled up to 1000 ml with distilled water.

0.1 g of the condensation product to be investigated is weighed into a 10 ml volumetric flask, filled up to 10 ml with distilled water and the respective sample solution is obtained.

100 μl of sample solution in each case are added, mixed with reagent solution and a mean residence time of 1.5 minutes is set, which corresponds to a flow of 35 ml/min.

For the determination of the absolute values, the flow injection apparatus is calibrated with formaldehyde solutions of known content.

### 1. Preparation of Reaction Solutions

### 1.1 Preparation of Reaction Solution 1.1

### Reactants:

a) phenol,
b) concentrated sulfuric acid,
c) formaldehyde,
d) urea

### Procedure:

2.04 kg of phenol are introduced into a stirring apparatus and treated with 2.48 kg of concentrated sulfuric acid (96% by weight) for 20 minutes. Care is to be taken here that the temperature does not exceed 105° C. Subsequently, the reaction mixture is stirred at 100 to 105° C. for 2 hours and then diluted with 0.34 kg of water of 20° C. and cooled to 70° C. 2.06 kg of aqueous urea solution (68% by weight) are metered in, the temperature rising to 95° C.; subsequently the mixture is cooled to 75° C. 4.10 kg of aqueous formaldehyde solution (30% by weight) are added over a period of 90 minutes, care being taken that the temperature does not rise above 75° C. Subsequently, it is partially neutralized using 0.78 kg of aqueous sodium hydroxide solution (50% by weight), 0.30 kg of water are added, and the mixture is subsequently stirred for 30 minutes and cooled further. 1.36 kg of phenol are added at a temperature of 50° C. 1.14 kg of aqueous formaldehyde solution (30% by weight) are subsequently metered in at 50° C. over 20 minutes and the mixture is subsequently stirred for a further 30 minutes at 55° C. The final adjustment of concentration and pH is carried out by addition of 1.40 kg of sodium hydroxide solution (50% by weight) and 2.5 kg of water. 18.5 kg of reaction solution 1.1 are obtained containing 43% by weight of nonvolatile fractions.

The analysis of reaction solution 1.1 affords the following values:

sodium sulfate by IC (based on nonvolatile fractions): 6.8% by weight;
phenol by HPLC (based on nonvolatile fractions): 0.36% by weight;
4-phenolsulfonic acid by HPLC (based on nonvolatile fractions): 2.89% by weight;
free formaldehyde: 75 ppm, based on nonvolatile fractions.

Mₙ=890 g/mol, M_{w}=7820 g/mol, determined by GPC.

### 1.2 Preparation of Reaction Solution

### Reactants:

a) dioxydiphenylsulfone
b) sodium sulfite
c) formaldehyde
b) sodium hydrogensulfate

1.3 l of water are introduced into a stirring apparatus and 4.1 kg of dioxydiphenylsulfone mixture (58% by weight) are added. The pH should be above 7.0. 0.8 kg of sodium sulfite is subsequently added and 1.155 kg of formaldehyde (30% by weight) are metered in. If required, the solution is neutralized using sodium hydroxide solution up to a pH of 8.0-8.5. The stirring apparatus is then closed, and the temperature is raised to the desired value of 115° C. As a result of the exothermic reaction which commences, the internal temperature increases to 150-155° C. and the reactor pressure to 4-4.5 bar. After reaching the internal temperature of 150° C., the desired temperature is reset to 150° C. and the reactor contents are kept at 150° C. for 8 hours before the solution is cooled to 70° C. with stirring. 400 g of sodium hydrogensulfate are then added to the solution. 7.8 kg of product containing 47% by weight of nonvolatile fractions are obtained.

The analysis of the product 1.2.1 affords the following values:

Mₙ=640 g/mol, M_{w}=3920 g/mol, determined by GPC.

### 1.3 Preparation of Reaction Solution 1.3

### Reactants:

a) phenol,
b) concentrated sulfuric acid,
c) formaldehyde,
d) urea

### Procedure:

2.04 kg of phenol are introduced into a stirring apparatus and treated with 2.48 kg of concentrated sulfuric acid (96% by weight) for 20 minutes. Care is to be taken here that the temperature does not exceed 105° C. Subsequently, the reaction mixture is stirred at 100 to 105° C. for 2 hours and then diluted with 340 g of water. 2.05 kg of urea solution (68% by weight) are metered in, care being taken that the temperature does not exceed 95° C. 3.60 kg of aqueous formaldehyde solution (30% by weight) are then added at 83 to 93° C. over a period of 1.5 hours. After a stirring time of 15 minutes, 800 g of aqueous sodium hydroxide solution (50% by weight) are added, care being taken that the temperature does not exceed 85° C., so that the pH is subsequently between 7.3 and 7.5. 11.3 kg of reaction solution 1.3 containing 47% by weight of nonvolatile fractions are obtained.

The analysis of reaction solution 1.3 affords the following values:

sodium sulfate by IC (based on nonvolatile fractions): 10.3% by weight;
phenol by HPLC (based on nonvolatile fractions): 0.74% by weight;
4-phenolsulfonic acid by HPLC (based on nonvolatile fractions): 1.36% by weight;
free formaldehyde: 99 ppm, based on nonvolatile fractions.
Mₙ=1990 g/mol, M_{w}=17 020 g/mol, determined by GPC.

### Filter Comprising at Least One Tanning Agent

Finishing of cotton and mixed fabrics with synthetic and/or plant tanning agents:

The fabrics are treated with an aqueous solution of the tanning agent(s) such that after drying a sufficiently large, uniformly distributed amount of tanning agent remains in the fabric.

### Procedure:

The fabrics are fulled for 60 min at 50° C. in a 40% strength tanning agent solution. Subsequently, they are dried for 90 min at 60° C. in a stream of dry air. The following fabrics/nonwovens are used in the examples: a) cotton nonwoven from Freudenberg (Weinheim, Germany), b) polycellulose nonwoven from Freudenberg, c) polypropylene nonwoven from Freudenberg.

Finishing of foams using synthetic and/or plant tanning agents:

A microporous foam (Basotect from BASF AG; cut into 100 mm×100 mm×7 mm disks) is impregnated with 25 ml of the tanning agent solutions according to the table and left at 50° C. for 30 minutes. The excess solution is removed by compressing between cellulose materials (15 g of the original solution). The moist foams are dried at 60° C. for 90 minutes in a stream of air. The weight increase is typically 2.5-4 g.

### EXAMPLES

Examples 1-6 describe typical formulations for the treatment of the filter substrates, it being possible to carry out the treatment both by spraying and by impregnating processes. Fixing is carried out by drying at 60° C. in a drying oven or in a stream of dry air. The compounds 1.1 and 1.2 are mentioned above as an example of a condensation product (A).

### Example 1

| | Composition range % | Actual example % |
|---|---|---|
| Water | 50-75 | 65 |
| Compound 1.1 | 15-30 | 19 |
| NM3 | 5-15 | 10 |
| NM2 | 5-15 | 6 |

### Example 2

| | Composition range % | Actual example % |
|---|---|---|
| Water | 50-75 | 65 |
| Compound 1.2 | 15-30 | 22 |
| NM3 | 5-15 | 8 |
| NM1 | 5-15 | 5 |

### Example 3

| | Composition range % | Actual example % |
|---|---|---|
| Water | 50-75 | 62 |
| Compound 1.1 | 15-30 | 19 |
| NM2 | 5-15 | 12 |
| Chestnut extract | 5-15 | 7 |

Chestnut extract (powder, Silvachimica srl, Italy, S. Michele Mondovi)

### Example 4

| | Composition range % | Actual example % |
|---|---|---|
| Water | 50-75 | 60 |
| Compound 1.1 | 15-30 | 22 |
| NM1 | 5-15 | 8 |
| Mimosa extract | 5-15 | 10 |

Mimosa extract (powder, Silvachimica srl, Italy, S. Michele Mondovi)

### Example 5

| | Composition range % | Actual example % |
|---|---|---|
| Water | 50-75 | 65 |
| Compound 1.2 | 15-30 | 15 |
| NM1 | 5-15 | 15 |
| NM2 | 5-15 | 5 |

### Example 6

| | Composition range % | Actual example % |
|---|---|---|
| Water | 50-75 | 65 |
| Compound 1.1 | 15-30 | 27 |
| NM3 | 5-15 | 6 |
| Epigallocatechol gallate* | 1-5 | 2 |

*green tea extract

6 different tanning agent formulations (examples 1-6) including chestnut extract and epigallocatechol gallate (green tea extract) are applied to 3 different carrier substrates (nonwoven cellulose, from Freudenberg, PP nonwoven (Freudenberg) and Basotect foam (BASF AG).

Testing for the inhibition of the virus activity is carried out to the greatest extent according to test procedure EN 14675 against avian influenza A virus (A/carduelis, H7N1).

First, the filter substrates as described above are flowed through for 15 minutes at 35° C. with water vapor-saturated air (35° C.). The virus suspension is subsequently sprayed onto the filters and flowed through for a further 30 minutes with moist air (35° C.). Before the determination of the titer, the filters are cut into small pieces of 10×10 mm and taken up with 50 ml of deionized water in a container.

The blank value (negative control) is in each case determined with the aid of the nonimpregnated carriers. The impregnated filters consistently produce significantly lower virus titers.

TABLE 1
Virus activity against avian influenza A virus
on different filter substrates with and without
(negative control) or different impregnation

| | | Titer of virus | Reduction |
|---|---|---|---|
| | | (TCID₅₀/ml) | (titer) |
| Substrate | Impregnation | log₁₀ | [%] |
| Cotton nonwoven | — | 6.1 | — |
| Cotton nonwoven | Ex. 1 | 1.7 | 72% |
| Cotton nonwoven | Ex. 2 | <1 | >84% |
| Cotton nonwoven | Ex. 4 | <1 | >84% |
| Cotton nonwoven | Ex. 5 | 2.3 | 62% |
| Polycellulose | — | 6.4 | — |
| nonwoven | | | |
| Polycellulose | Ex. 3 | 1.4 | 78% |
| nonwoven | | | |
| Polycellulose | Ex. 4 | <1 | >84% |
| nonwoven | | | |
| Polycellulose | Ex. 5 | 1.6 | 75% |
| nonwoven | | | |
| Polycellulose | Ex. 6 | <1 | >84% |
| nonwoven | | | |
| PP nonwoven | — | 4.8 | — |
| PP nonwoven | Ex. 2 | <1 | >79% |
| PP nonwoven | Ex. 3 | 1.5 | |
| PP nonwoven | Ex. 4 | <1 | >79% |
| PP nonwoven | Ex. 5 | 1.3 | |
| PP nonwoven | Ex. 6 | <1 | >79% |
| Basotect foam | — | 3.9 | — |
| Basotect foam | Ex. 2 | <1 | >74% |
| Basotect foam | Ex. 4 | <1 | >74% |
| Basotect foam | Ex. 5 | <1 | >74% |
| Basotect foam | Ex. 6 | <1 | >74% |

1. A method of avoiding infections by applying to or introducing one or more synthetic tanning agents into a filter.

2. The method according to claim 1, wherein the filter comprises a natural or synthetic fibrous fabric, a foam, a film, a textile, polymer fibers or a matrix having cavities within the matrix.

3. The method according to claim 1, wherein the filter is part of a respiratory production apparatus, of a drape or of a surgical mask or wherein the filter in each case completely forms these articles.

4. The method according to claim 1, where a depletion or elimination of microorganisms form the air, is achieved by means of the synthetic tanning agent.

5. The method according to claim 1, wherein the natural or synthetic fibrous fabric is woven or nonwoven fibrous fabric or the foam is a polyurethane-amino resin condensate.

6. The method according to claim 5, wherein the woven or nonwoven fibrous fabric is cellulose, cellulose derivatives, cotton; nonwoven wool, silk, polyamides, polypropylene, polyester, other plastics or glass fibers or the polyurethane-amino resin condensate is a melamine-formaldehyde condensate.

7. The method according to claim 1, wherein the synthetic tanning agent is at least one condensation product selected from the group consisting of:
condensation product (A) obtained by reaction of
a1) at least one aromatic system or heteroaromatic system,
a2) at least one carbonyl compound,
a3) optionally, at least one sulfonating agent and
a4) optionally, at least one urea derivative;
condensation product (B) obtained by reaction of
b1) at least one cyclic organic carbonate with
b2) at least one compound having at least two nucleophilic groups per molecule, selected from the group consisting of sulfonic acid groups, hydroxyl groups, primary or secondary amino groups or mercapto groups; or
condensation product (C) obtained by reaction of
c1) melamine or urea,
c2) glyoxal, glycolic acid or an alkali metal salt thereof,
c3) optionally, at least one aromatic compound having at least one phenolic hydroxyl group and
c4) optionally, at least one condensable compound having a reactive nitrogen-containing group.

8. A filter comprising at least one tanning agent.

9. The filter according to claim 8, wherein the filter comprises a natural or synthetic fibrous fabric, a foam, a film, a textile, polymer fibers or a matrix having cavities within the matrix.

10. The filter according to claim 8, wherein the filter is part of a respiratory production apparatus, of a drape or of a surgical mask or wherein the filter in each case completely forms these articles.

11. The filter according to claim 8, wherein the natural or synthetic fibrous fabric is woven or nonwoven fibrous fabric, that of is cellulose, cellulose derivatives, cotton; nonwoven wool, silk, polyamides, polypropylene, polyester, other plastics or glass fibers and/or the foam is a polyurethane-amino resin condensate is a melamine-formaldehyde condensate.

12. The filter according to claim 11, wherein the woven or nonwoven fibrous fabric is cellulose, cellulose derivatives, cotton; nonwoven wool, silk, polyamides, polypropylene, polyester, other plastics or glass fibers or the polyurethane-amino resin condensate is a melamine-formaldehyde condensate.

13. The filter according to claim 8, which additionally at least one plant tanning agent.

14. The filter according to claim 8, wherein the synthetic tanning agent is at least one condensation product selected from the group consisting of:
condensation product (A) obtained by reaction of
a1) at least one aromatic system or heteroaromatic system,
a2) at least one carbonyl compound,
a3) optionally, at least one sulfonating agent and
a4) optionally, at least one urea derivative;
condensation product (B) obtained by reaction of
b1) at least one cyclic organic carbonate with
b2) at least one compound having at least two nucleophilic groups per molecule, selected from the group consisting of sulfonic acid groups, hydroxyl groups, primary or secondary amino groups or mercapto groups; or
condensation product (C) obtained by reaction of
c1) melamine or urea,
c2) glyoxal, glycolic acid or an alkali metal salt thereof,
c3) optionally, at least one aromatic compound having at least one phenolic hydroxyl group and
c4) optionally, at least one condensable compound having a reactive nitrogen-containing group.

15. The filter according to claim 8, wherein the synthetic tanning agent is introduced into the filter or is applied to the filter in the form of a coating.

16. A process for the production of a filter according to claim 8, comprising at least one synthetic tanning agent to the filter or is introduced into the filter.

17. The process according to claim 16, wherein the filter is filled, sprayed or treated in the roll coating process with an aqueous solution of one or more synthetic tanning agents.

18. A method of avoiding infection, comprising a filter according to claim 8.

19. The method according to claim 4, wherein the microorganisms are viruses or bacteria.
